(19) United States
(12) Patent Application Publication
(10) Pub. No.: US 2026/0100383 A1
(43) Pub. Date: Apr. 9, 2026

(54) ELECTRODE WITH PROTECTED CARBON BASED SCAFFOLD

(71) Applicant: LionVolt B.V., Eindhoven (NL)

(72) Inventors: Sandeep Unnikrishnan, Eindhoven (NL); Hossein Mardanpour Mollalar, Eindhoven (NL); Namdar Kazemi, Eindhoven (NL)

(21) Appl. No.: 19/155,060

(22) PCT Filed: Feb. 9, 2024
(86) PCT No.: PCT/NL2024/050068

§ 371 Date: Aug. 8, 2025

(30) Foreign Application Priority Data
Feb. 10, 2023 (NL) 2034124

(51) Int. Cl. H01M 4/78; H01M 4/02; H01M 4/38; H01M 4/66

(52) U.S. Cl. CPC H01M 4/78; H01M 4/381; H01M 4/661; H01M 4/664; H01M 4/667; H01M 4/668; H01M 2004/027

(57) ABSTRACT

The present disclosure provides as an electrode 1, comprising a 3D composite current collector 2 having an electrically conductive substrate current collector 3 with a plurality of laterally distributed electrically conductive upstanding scaffolding elements 4 that comprise carbon-based protrusions 6 covered by a passivation layer 10 for shielding the pillar from a direct contact with an electrode or electrolyte material, whereby said passivation layer (10) is comprised of a first composition (10c) allowing electron transport to the substrate and resistive to transport of lithium across the passivation layer.

In a preferred embodiment the electrode is coated with a stack of functional battery layers including one or more of a seed layer 20, an anode metal layer 30, and an anode passivation layer 40.

The present disclosure further relates to a manufacturing method and an energy storage device comprising the electrode.

### TECHNICAL FIELD AND BACKGROUND

The present disclosure relates to an electrode, in particular an electrode comprising a 3D composite current collector. The present disclosure further relates to an energy storage device comprising the electrode and a method of manufacturing.

Rechargeable lithium-ion battery (LiB) technology is considered a potential technology of choice for next-generation energy carriers in a global energy shift, e.g. in traffic electrification and in renewable energy storage grids. State-of-the-art LiBs aims at improving safety issues related to the liquid nature of the electrolyte while improving current energy density of about ˜270 Wh/kg at the cell level due to the limited capacity of graphite (370 mAh/g) at the anode. To increase feasibility for electromobility a combination of higher energy density cells (e.g. >400 Wh/kg) and use of intrinsically safe solutions is targets. One way can be by transitioning towards all solid-state batteries with lithium metal anodes enabling a potential high specific capacity of 3860 mAh/g and a redox potential of −3.04 V.

However, the cycle life of lithium metal anodes suffers from porosity and dendrite formation as a consequence during battery charging, e.g. in liquid electrolytes. In addition lithium metal batteries suffer from one or more of several other issues including cell short circuits due to hillocks formation (uneven Li metal deposition); and adverse reactions, such as evolution of dead Li wrapped by a film of solid-electrolyte interphase (SEI) reaction product which can over time lead to formation of a porous, non-uniform, anode structure which in turn can lead to increased diffusion pathways of Li ions and electrons, and thus to an increased polarization. These porous deposits can also prompt progressively large volumetric changes within the anode during plating/stripping cycle, leading to poor life cycle stability.

U.S. Pat. No. 10,741,835 discloses an anode structure for a lithium metal battery that includes a current collector, a seed layer selected to promote electrochemical plating of metallic lithium deposited onto the current collector, a separator, and a host structure between the seed layer and the separator to host metallic lithium during charging. First and second adhesion layers are required to respectively bond the host structure to the seed layer and to the separator.

S. Yoon (Journal of Power Sources, 2015 279, 495) describes film anodes carbon nanotube (CNT) for use in flexible lithium ion batteries. The film anodes are based on disordered carbon nanotubes and are prepared by chemical vapor deposition and direct spinning. The carbon nanotubes carry the anode metal. The study proposes heat-treatment under nitrogen atmosphere to affect performance.

JP2006156351A relates to an anode for lithium metal polymer secondary battery. The anode is made of anode current collector metal foil or metal foam having a surface on which a plurality of recesses are recessed in a predetermined shape in the metal current collector either chemically by etching the surface or physically by pressing the surface of the metal current collector. The 3D metal structure contributes to a dead weight of the secondary battery.

DE102010008782A1 relates to a negative electrode which comprises a conductive polymer matrix (metallized fabric or fleece) coated with metal or a metal alloy as a current collector and a composite at least partially embedded therein, which contains at least one metal or semi-metal or an alloy and/or intermetallic phase thereof which can form an alloy or an intermetallic phase with lithium.

EP3261157 describes a battery with a substrate current collector with metal pillars as conductive structures, covered with electrode and electrolyte layers. An insulator covers part of the conductive structure to prevent a conductive path between the first and second electrode. The metal pillars contribute to a dead weight of the battery, and the insulator that prevents a conductive path between the electrodes contributes to internal resistance in the battery.

### SUMMARY

The present disclosure mitigates one or more of the above disadvantages by providing an anode, in particular an electrode comprising a 3D composite current collector, with particular benefits for use in, or as host for, a metal anode, while offering a combination of increased safety and cycling stability.

In general, the concept for the 3D structured electrode comprises a conductive carrier comprising a 3D scaffold structure comprising a plurality of carbon-based protrusions, e.g. upstanding pillar structures, which are coated to serve as anode in a metal electrode-based battery. The 3D scaffold structures can be of any geometric shape, preferably as upright pillars or more preferably structures with holes or upstanding wall structures.

More particular, in a preferred concept, the carbon-based protrusions of the 3D structured electrode comprises an electrically conductive 3D vertically aligned carbon nanotube scaffold which is densified and subsequently coated and can e.g. serve as anode in a metal electrode-based battery.

In another preferred concept, the 3D structured electrode comprises spatially separated upstanding polymer protrusions, e.g. pillars or wall structures, which are coated and can e.g. serve as anode in a metal electrode-based battery.

Preferably, the electrode is suitable as an anode for in a metal electrode-based battery.

The 3D composite current collector comprises an electrically conductive substrate current collector with a plurality of laterally distributed electrically conductive upstanding scaffolding elements.

The scaffolding element comprises a carbon-based protrusion extending in a direction away from a base at the substrate. In a preferred embodiment the scaffolding elements comprise a structure of agglomerated carbon nanotubes that are oriented largely parallel in a direction away from the substrate. Alternatively or additionally, the scaffolding elements comprise a polymer-based protrusion. The carbon-based protrusions may be electrically conductive, which is typically the case for structures of agglomerated carbon nanotubes, or the carbon-based protrusions may be electrically resistive, which is often the case for polymer materials.

In embodiments, for one or more of the scaffolding elements, the carbon-based protrusion comprises a structure of agglomerated carbon nanotubes. Alternatively or additionally, for one or more of the scaffolding elements, the carbon-based protrusion is a polymer-based protrusion.

The carbon-based protrusions, e.g. the structure of agglomerated carbon nanotubes or polymer protrusions, are covered by a passivation layer. The passivation layer defines an external wall that encapsulates the underlying composition, especially the polymer or the structure of agglomerated carbon nanotubes. The passivation layer serves to protect the underlying carbon-based protrusion from a base at the electrically conductive substrate current collector, along its sidewalls, up to and including a top face at a distal end of the structure, top, away from the substrate.

As will be explained herein in more detail the electrode as disclosed herein can be used to advantage in a number of applications or configurations including, but not limited to, an anode comprising said electrode, a cathode comprising said electrode, and an energy storage device comprising the electrode, e.g. in or as one or more of an anode and a cathode comprised therein. Generally these applications/configurations involve supplying one or more subsequent layers of a functional material along an external face of the current collector forming a multi-layer stack, e.g. a lithium metal battery multilayer. As such the upstanding scaffolding elements can be understood to support the one or more subsequent layers of functional materials, e.g. battery active layers, while providing a function of distributed current collection/distribution to/from the subsequent layers. Additionally, and as will be explained in more detail herein below, the upstanding scaffolding elements can be understood to reduce the current density on the 3D surface, improve homogeneity of anode and/or cathode material distribution, mitigate formation of dendrites, mitigate irreversible loss of anode material during battery manufacturing and/or battery cycling, and/or mitigate loss of power density upon over battery lifetime.

According to a first aspect, there is provided an electrode, comprising a 3D composite current collector, comprising an electrically conductive substrate current collector with a plurality of laterally distributed electrically conductive upstanding scaffolding elements, wherein the scaffolding element comprises: a carbon-based protrusion extending in a direction away from a base at the substrate; and a passivation layer covering upstanding sidewalls inclusive a tip of said carbon-based protrusion, whereby said passivation layer is comprised of a first composition allowing electron transport to the substrate and resistive to transport of lithium (metallic metal and lithium-ions) across the passivation layer.

The passivation layer advantageously protects the underlying protrusion of the scaffold elements from a direct contact with an electrode material and/or an electrolyte material, mitigating or even essentially preventing degradation thereof by adverse chemical reaction with battery active material, e.g. redox reactions due to a contact between lithium metal and the carbon-based composition comprised in the protrusion. Additionally, by using a passivation layer allowing electron transport to the substrate, electrical conductivity of the substrate current collector can be preserved, even in case electrically non-conductive carbon-based protrusions (e.g. polymer protrusions) are used. The passivation layer may also advantageously provide a well-defined and/or smooth surface, irrespective of the material of the underlying protrusion. Such a well-defined and/or smooth surface is typically more suitable for deposition of an electrode material than an external surface of a carbon-based protrusion, which can in some cases be irregular, porous, and/or fluffy, depending on the type of material.

The passivation layer is comprised of a first composition 10c allowing electron transport to the substrate while being resistive to transport of anode material and/or an electrolyte material, e.g. lithium across the passivation up to the protrusion structure. An elongate interspace structure is defined in complementary spaces between opposing sidewalls of adjacent ones of the scaffolding elements.

In a preferred embodiment, the carbon-based protrusion is tapered towards the tip, e.g. a tapered pillar. A tapered shape can advantageously increase an overall surface of the 3D current collector with comparatively reduced volume of battery inactive materials. In addition, and as will be clear from the below, the surface of slanted sidewalls of the tapered protrusions improves control over a thickness of subsequently added cover layers (e.g. by vapor deposition), as opposed to vertical walls.

In a preferred embodiment, the carbon-based protrusion comprises an organic polymer.

In another preferred embodiment the carbon-based protrusions are comprised of upstanding pillars formed of a carbon-based polymer or polymeric composition material. Carbon-based polymers refer to polymers in which the polymer backbone comprises carbon-carbon bonds, for instance an organic polymer or polymer composition. The polymer protrusions can be comprised of thermoplastics, thermosets and/or elastomers. Suitable polymers may be selected from list including, but not limited to: polyethylene, polypropylene, polyolefin, polystyrene, polycarbonate, polyethylene terephthalate, polyamide, polyacrylate, polyurethane and liquid crystal polymers (LCPs), epoxies. In some embodiments the protrusion, e.g. pillar, essentially consists of an organic polymer.

As compared to metal or ceramic protrusions carbon-based protrusions (such as protrusions comprising carbon nanotubes and/or polymer-based protrusions) can have a comparatively reduced overall contribution to an overall weight of the electrode, improving for example a power to weight performance of an energy storage product.

Alternatively, or in addition, the protrusions, e.g. pillar structure, may be a composite, e.g. comprising a polymer composition comprising one or more fillers and/or cover layers. Fillers and/or cover layers can advantageously increase mechanical stability and/or temperature stability of the protrusion. For example, in view of temperature variations or volumetric variations during anode manufacturing and/or operational lifetime within a battery. Preferably, fillers are in the form of particles, such as nanoparticles. Examples of suitable fillers are metal particles, carbon particles, ceramic particles, or combinations thereof. Electrically conductive particles (e.g. carbon particles or metal particles) can be applied to increase electrical conductivity of the protrusions.

Fillers may be present in the protrusion in an amount of 0-50 wt. % relative to the weight of the composite protrusion, for instance 0-30 wt. % or 1.0-25 wt. %. When too much filler is present, this may negatively affect the structural properties and/or the weight of the protrusions.

Alternatively or additionally to the presence of fillers and/or cover layers, protrusions that comprise a polymer composition may comprise pores. Advantageously, such pores can be applied in order to reduce weight of the carbon-based protrusions. Preferably, the pores represent a volume of 0-50 vol. % relative to the volume of the protrusion, for instance 0-30 vol. % or 1.0-25 vol. %. Too much pore volume may negatively affect the structural integrity of the protrusions.

In some embodiments, the passivation layer includes a metal layer, which metal layer optionally includes a portion extending along a face of the substrate thereby interconnecting adjacent ones of the electrically conductive upstanding scaffolding elements. The metal layer can advantageously increase a current collection to/from the substrate, especially in case the metal extends between adjacent protrusions.

Alternatively, or in addition, the passivation layer can include a layer of a semi-conducting material. Semi-conducting materials, having an electrical conductivity between that of an insulator and a conductor (e.g. metal) have a benefit of providing adequate current collection while, by virtue of resistivity, during battery operation decrease an effective field in a direction towards the scaffold tips so that plating potential of anode metal (e.g. Li) can de comparatively reduced near tips of the scaffold elements, thereby mitigating a risk of dendrite formation and/or improving battery cycle life time. Suitable semi-conducting materials include Titanium Nitride, Zirconium Nitride, Indium Tin Oxide etc. To minimize overall reduction current collection performance the layer of semi conduction material preferably does extent between adjacent scaffolding elements. Most preferably, the layer of semi conducting material is restricted to the upstanding protrusion.

In a preferred embodiment, the passivation layer is laminate, said laminate including: the metal layer, which optionally includes a portion extending along a face of the substrate; and a layer of the semi-conducting material, whereby the layer of the semi-conducting material covers the metal layer and does not interconnect adjacent ones of the electrically conductive upstanding scaffolding element between adjacent protrusion.

In other or further preferred embodiments, a thickness of the semi-conducting layer along the upstanding sidewall increases in direction towards the tip. This progressively further reduces an effective field at scaffold tips.

Preferably, the electrode can further comprise a sublayer extending between the carbon-based protrusion and the passivation layer. The sublayer can increase a mechanical and/or thermal stability of the carbon based protrusion, especially organic polymer protrusion. The sublayer is preferably formed of an electric insulator and does interconnecting adjacent ones of the electrically conductive upstanding scaffolding element. Suitable materials include ceramics and metal oxides, including but not limited to, silicon oxides, aluminum oxides, etc.

The first composition comprised in or essentially forming the passivation layer can be formed of a metal selected from one or more of a group including but not limited to Cu, Ni, Al, and stainless steel Metals or metal composition that accept negligible amounts of lithium can advantageously combine electronically conductivity with effective blocking of lithium diffusion.

In some embodiments, wherein the first composition comprises or essentially consists of an electrical insulator (for example Al2O3 or TiO2) having a thickness and resistivity configured to form a tunnel junction.

To improve plating homogeneity of anode metal along the scaffold surface a seed layer covering the scaffolding elements can be provided. The seed layer can comprise a composition selected for alloying with Lithium (for example Sn, In, Zn, Ag, Au etc.).

In some embodiments, the electrode further comprises an alkali metal anode layer (e.g. lithium) covering the plurality of scaffolding elements. The layer can be provided prior to an initial charging cycle of the battery (e.g. from an external source). Alternatively the layer can be formed as a result of an initial or further charging cycle of a battery. To reduce reactivity at an exposed surface of the anode metal an anode passivation layer can be provided which preferably completely covers said anode metal layer. The anode passivation layer can, for example be comprised of a metal or metalloid composition alloying with lithium metal. Alternatively, or in addition, the anode passivation layer can be an comprised of an organic or inorganic composition or a mixture thereof, as in known SEI layers.

In yet further embodiments, the electrode can comprise an electrically insulating cap. The cap is provides so covering tops of the scaffolding elements to reduces an electrical field at the tops. The electrically insulating cap can be provided: onto the anode passivation layer, between the anode metal layer and the anode passivation layer, or onto the seed layer.

In other or further embodiments, the electrode further comprises an electrolyte covering the scaffolding elements. Alternatively, or in addition, the electrode can further comprise particles of an anode or cathode material.

An aspect ratio as defined by a height of the protrusion divided by its lateral dimension, can for polymer-based pillars be in a range of 1:1 to 10:1 or up to 20:1

In a preferred embodiment, the electrically conductive substrate is provided as flexible metal foil or as a metal coated flexible carrier. Flexible substrates can advantageously be used to provide a curved or even flexible electrode. Additionally, flexible substrates can be processed effectively and consistently by a continuous manufacturing processes such as roll to roll processing.

The electrode may also comprise an optional intermediate layer between the scaffolding elements and the substrate current collector, wherein said intermediate layer is chemically inert toward the substrate current collector. In this way, degradation of the substrate current collector by reaction with the scaffolding elements, for instance oxidation of the substrate current collector, can be mitigated or even avoided. Alternatively or additionally, adhesion of the scaffolding elements to the substrate current collector can be improved. Suitable materials for the intermediate layer include ceramic materials, such as metal oxides, titanium nitride, zirconium nitride, and indium tin oxide.

To allow flexibility of formed electrodes the laterally distributed electrically conductive upstanding scaffolding elements can be segmented in sectors, each sector having a lateral separation from an adjacent one by a gap in accordance with an intended substrate bending axis.

In some embodiments, the electrode as disclosed herein can be provided on opposing faces of a single carrier substrate. Depending on the subsequent cover layers, e.g. the type provision battery active material provided on either face, these dual electrodes can be used for series or bipolar assembly of a battery stack.

Further aspects of the present disclosure relate to an energy storage device comprising the electrode as disclosed herein, such as a lithium metal battery. In some embodiments the storage device can comprise a composite solid electrolyte membrane separating opposing anode and cathode sides of the storage device.

Yet further aspects relate to a method of manufacturing an electrode and/or battery as disclosed herein. Accordingly, there is provided a method of manufacturing an electrode as disclosed herein. Said method comprising: providing a 3D composite substrate current collector, having an electrically conductive substrate current collector comprising a plurality of laterally distributed carbon-based protrusions extending in a direction away from a base at the substrate; and covering upstanding sidewalls inclusive a tip of said carbon-based protrusion with a passivation layer (10) comprised of a first composition (10c) allowing electron transport to the substrate and resistive to transport of lithium across the passivation.

### BRIEF DESCRIPTION OF DRAWINGS

These and other features, aspects, and advantages of the apparatus, systems and methods of the present disclosure will become better understood from the following description, appended claims, and accompanying drawings wherein:

FIG. 1A depicts a cross-section side view of an electrode as disclosed herein;

FIG. 1B depicts a partial cross section side view of an embodiment of an electrode as disclosed herein;

FIGS. 1C to 1G provide partial cross-section views of embodiments of the electrode as disclosed herein;

FIGS. 2A and 2B depict partial cross section side views of embodiments of 3D anodes comprising an electrode as disclosed herein;

FIG. 3A, depicts a cross section top-view of an electrode as disclosed herein;

FIGS. 3B, 4A, and 4B depict various embodiments of a 3D anode including an electrically insulating cap;

FIG. 5A illustrates further aspects of an electrode as disclosed herein;

FIG. 5B depicts a cross-section side view of an electrode as disclosed herein;

FIG. 6A schematically illustrates an exploded side view of a battery comprising an electrode as disclosed herein;

FIGS. 6B and 6C illustrate further aspects of an electrode as disclosed herein;

FIG. 7A schematically illustrates a method of manufacturing an electrode as disclosed herein; and

FIG. 7B provides schematic top-views of aspects relating to the manufacturing of an electrode as disclosed herein.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

As used herein the terms anode and anode composition can be understood as relating to elements and materials, which upon a normal discharge routine of a battery serve as negative electrode respectively materials releasing electrons upon an electrochemical oxidizing reaction with an anode/anode material, which acts as acceptor/reducing material. Cathode and cathode composition relate to the corresponding counterparts (positive electrode/electron acceptor). During charging routines the role of oxidizing/reducing agent are obviously reversed.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

It will be appreciated that, where specific features are described/depicted in relation to an embodiment comprising an agglomerated structure of carbon nanotubes, said features are equally envisioned in relation to other carbon-based structures (for example polymer based pillars), unless stated to the contrary or clear from context.

Conversely, it will be appreciated that features described/depicted in relation to an embodiment comprising a polymer-based protrusion, are equally envisioned in relation to embodiment having a carbon-nanotube based protrusion, unless stated to the contrary or clear from context.

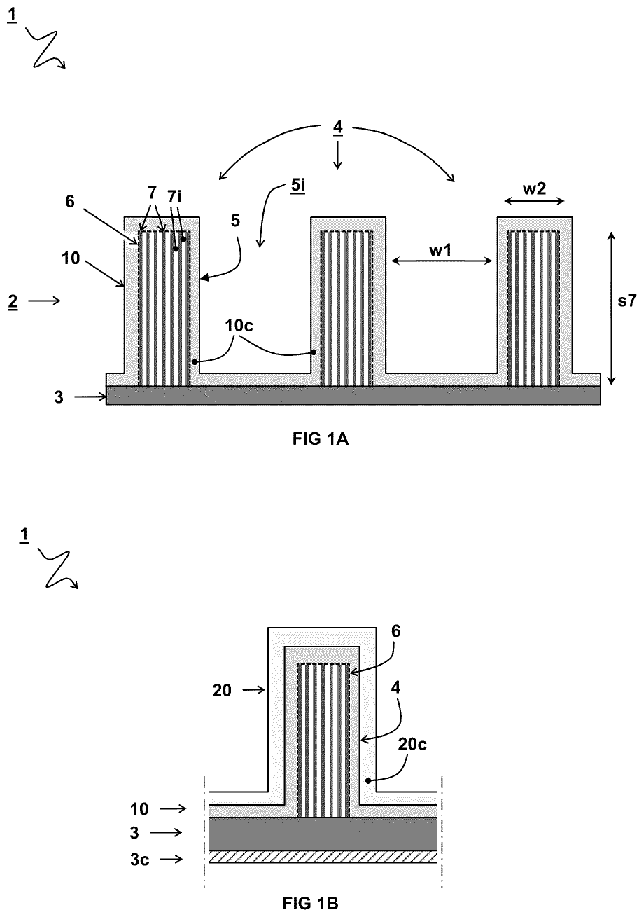

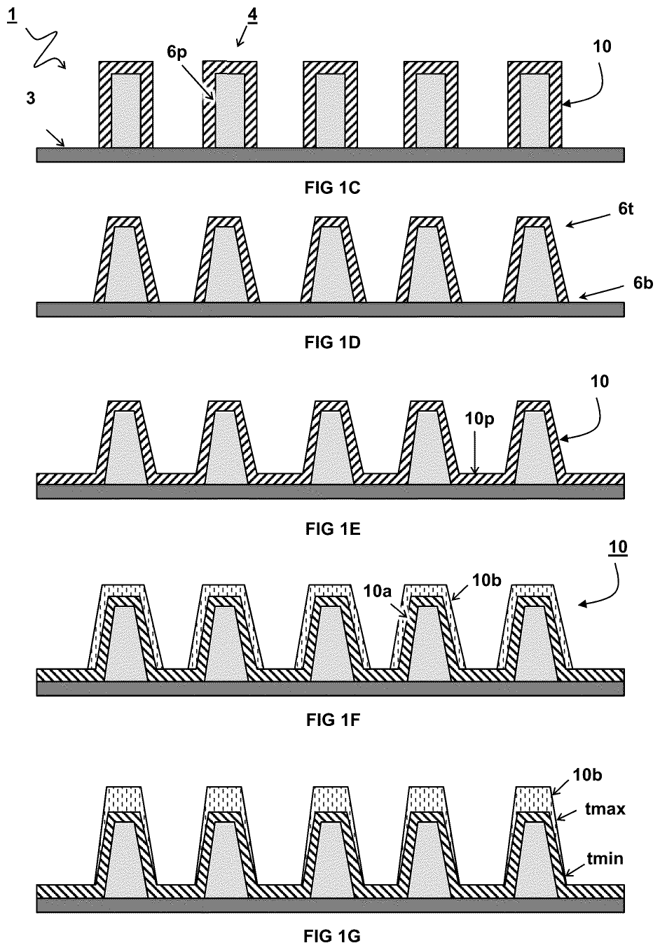

FIG. 1A depicts a cross-section side view of an electrode 1 as disclosed herein. The electrode is illustrated as comprising a 3D composite current collector 2. The current collector comprises an electrically conductive substrate current collector 3 with a plurality of laterally distributed electrically conductive upstanding scaffolding elements 4. The scaffolding element 4 comprises a carbon-based protrusion 6, in this case a structure of agglomerated carbon nanotubes 7 that are oriented largely parallel in a direction away from the substrate 3. The carbon-based protrusion 6 is covered by a passivation layer 10 for shielding the carbon nanotubes 7 from a direct contact with an electrode material (e.g. anode metal) and/or electrolyte, whereby said passivation layer 10 is comprised of a first composition 10c allowing electron transport to/from the structure of agglomerated carbon nanotubes. The passivation layer 10 defines an outer wall, including sidewalls 5 of the upstanding scaffolding elements. Between adjacent scaffolding elements 4 elongate interspace structures 5i provide space for sequent functional layers.

Advantageously, the electrically conductive substrate can be provided as flexible metal foil, e.g. a copper foil, or as illustrated in FIGS. 1B, 5A, 6A and 6B a metal coated flexible carrier 3C, e.g. a metal coated plastic film. Flexible metal foils and/or metal coated carriers advantageously allow the electrodes to be coiled up, follow a geometry of an external 3D shaped carrier, and/or enable a reduction of manufacturing time by enabling roll-to-roll manufacturing processes.

It will be understood that the shape and dimensioning of the scaffolding elements 4 can depend on the application. Typically, the height s7 of the carbon-based protrusions 6 is at least 2 μm. The taller the structures the more pronounced the effect of 3D current collection, e.g. the larger the amount, volume, of electrode material that can be in electrical communion with the current collector. An upper limit can be merely defined by process limitations. For example, a limitation as to provision of carbon nanotube structures beyond a certain upper limit, e.g. >100 micrometers (μm), and/or limitations as to providing conformal coating layers at a base of the structures. Structures having a height in a range of 5 μm-50 μm were found to strike a practical balance between device performance, e.g. overall capacity, and complexity of manufacturing.

Between the electrically conductive substrate current collector and the carbon nanotubes a buffer layer is generally provided from which the carbon nanotubes are grown. As known in the field, the buffer layer typically includes a layer of an oxides, which can be a conductive oxide onto which catalyst seed particles are provided that catalyze carbon nanotube growth. Depending on growth conditions catalyst residues can remain at a bottom interface of the carbon nanotubes (base-type carbon nanotubes growth) and/or catalyst remains can present at terminal tips of carbon nanotubes (tip-type growth).

A lateral separation w1 between opposing sidewalls 5 of adjacent carbon-based protrusions 6, e.g. agglomerated structures of carbon nanotubes 7 determines a dimensioning of the interspace structure 5i and thus volume available for deposition of subsequent layer(s) of electro-active materials (for instance electrode or electrolyte materials). The closer adjacent scaffolding elements are positioned the more homogeneous current collection from a subsequent cover layer can be. The further adjacent scaffolding elements are separated and the smaller their lateral dimension and the more volume available for subsequent layers of functional electro-active materials and the smaller their relative contribution of carbon nanotubes.

A practical range for a lateral dimensioning of the structures, e.g. a cross-section separation w2 between opposing sidewalls 5 of a carbon-based protrusion 6, was found to be in a range of 0.1 μm-20 μm. The thinner the structure the smaller the contribution of the carbon nanotube structures to an overall weight and volume relative to electro-active materials disposed on top and in between along the structures. A value of about 100 nm was found to constitute a practical lower limit of a practical balance between increasing reduction and manufacturing complexity.

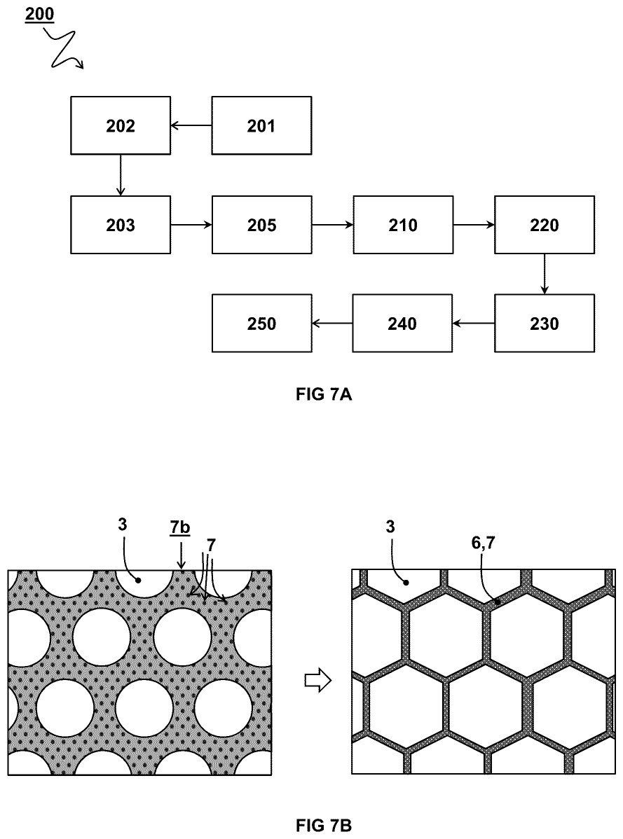

The shape of the scaffolding element can include one or more of isolated structures such as pillars or columns, wall structures having an elongate dimension in a lateral direction along the substrate; patterned, e.g. zig-zagging wall structures, and interconnected wall structures having wall sections. While pillar-shaped structures can offer the largest surface area per unit volume of carbon, scaffolding elements having a smaller surface/volume ratio such structures having a dimension extending laterally in a direction along the substrate, such as wall sections, patterned wall sections (e.g. zig-zag), or even interconnected wall sections can advantageously offer increased resilience to forces along in a lateral direction (e.g. bending). FIG. 7B (right) provides a top view of an exemplary structure of agglomerated carbon nanotubes arranged in a hexagonal pattern.

The passivation layer 10 comprises, or essentially, consists of a first composition 10c allowing electron transport to/from the structure of agglomerated carbon nanotubes. The passivation layer of the first composition 10c extends along an external face of the agglomerated structure of carbon nanotubes from a base at the electrically conductive substrate current collector up to and including terminal ends, tips, of the structure. Obviously the passivation layer can also extend along the electrically conductive substrate current collector 3 between adjacent ones of the carbon-based protrusions 6 (e.g. between adjacent structures of agglomerated carbon nanotubes or between adjacent polymer-based protrusions).

Advantageously the passivation layer 10 can form an essentially closed coating, shell, while allowing electron transport capabilities to/from the structure of agglomerated carbon nanotubes. Providing an essentially closed shell mitigates foreign substances, such as electroactive materials, from contacting individual carbon nanotubes 7 and from entering an interior volume 7i within the structure, i.e. between adjacent carbon nanotubes 7.

Thus application of the shielding coat, i.e. passivation layer 10 was found to: mitigate reduction or even a prevent degradation of current collection capabilities of the carbon nanotube structures due to an interaction, e.g. an irreversible chemical reaction, between the carbon nanotubes, in particular at defects sites, due to a direct contact with electro-active materials, in particular highly reactive anode metal compositions. Additionally, the passivation layer 10 was found to minimize a loss of functional electro-active materials, e.g. anode metal, due to interactions with carbon nanotubes. Yet further, the passivation layer 10 is found to increase structural integrity of the scaffold 4 and increasing cycle-life of electrochemically active devices comprising the electrode 1 by mitigating volumetric changes within the carbon-based protrusion 6 by hindering or essentially avoiding infiltration of electrode metal/metal ions into void spaces of carbon-based protrusion 6, such as pores in a porous polymer-based protrusion or an interior 7i of a structure of agglomerated carbon nanotubes 7.

Advantageously the passivation layer 10 can be provided such that infiltration of passivation material within the structure of agglomerated carbon nanotubes past an outermost portion surrounding an inner core can be minimized such that the coating material forms a shell whereby voids defined as space between adjacent ones of the agglomerated carbon nanotubes at a central portion of the structure can remain essentially free of coating material, i.e. first composition 10c. Obviously shielding material can penetrate to some extent between carbon nanotubes at an outermost portion of the structure of agglomerated carbon nanotubes forming a composite zone. However, as will be explained in more detail herein below a thickness of this composite zone can be well below 25 nm, e.g. <5 nm or less, leaving a core wherein the agglomerated carbon nanotubes can remain in an uncoated state. Restricting the passivation composition to an outermost portion of the structure advantageously minimizes an overall weight per unit volume of the electrode while retaining current collection/distribution properties.

In general the passivation layer 10, comprises or essentially consists of a composition, referred to as first composition 10c, having a reduced reactivity towards carbon nanotubes, in particular defects sites, relative to the anode or cathode compositions, and corresponding electrolyte compositions the electrode is contacted with. Preferably, the composition 10c is selected to have a significantly reduced, preferably a negligible, electrochemical activity under normal operating potentials.

Inventors found that the object of providing a closed passivation layer 10 for shielding the carbon nanotubes 7 for preventing a direct contact with external materials while allowing electron transport to/from the carbon-based protrusion 6 can be attained by electrically conductive compositions.

Accordingly, in some embodiments, the first composition 10c (comprised in or essentially making up the passivation layer) comprises or essentially consists of a metal, metalloid, or mixture of one or more metals and/or metalloids, e.g. an alloy.

Metal and/or metalloid-based compositions for the passivation layer 10 are generally selected from elements having an electronegativity >1.5 on the Pauling scale. Preferred compositions 10c may comprise or essentially consist of elements selected from the late-d and early p-blocks of the periodic table, i.e. groups 9-14 from the periodic table. To shield the carbon nanotubes 7 from a direct contact with an electrode or electrolyte material (electro-active materials) such as anode metal compositions, e.g. metals selected from the alkali and/or alkaline earth metals, including but not limited to Li, Na, K, and Mg, the metal and/or metalloid-based composition for the passivation layer is preferably formed of a significantly more noble composition comprising or preferably essentially consisting of elements selected from a group consisting of Nickel, Copper, Titanium, Aluminum, and combinations thereof, of which Copper, Nickel and alloys thereof are most preferred from a practical and/or economical perspective. Of course semi conducting materials including, but not limited to, TiN, ZrN or ITO can be used as alterative or in addition.

To shield the carbon nanotubes 7 from a direct contact with cathode compositions and/or electrolyte it was found that in principle similar compositions can be used whereby Aluminum was found to be particularly stable and Copper was found less preferable, due to a comparatively lower electrochemical stability, particularly at high working potentials (>3 V). The thickness of the metal- or metalloid based passivation layer 10 is at least so as to provide a functionally closed, conformal, cover layer. Suitable deposition techniques include dry vapor-based deposition methods such as PVD (physical vapor deposition), ALD (atomic layer deposition), and spatial ALD, optionally followed by wet-deposition techniques such as electro-chemical deposition or plating to increase a thickness of the passivation layer 10. In absolute terms the metal or metalloid-based passivation layers can already be formed with a thickness of about 2 nm. To reduce a density of point defects the thickness is preferably >5 nm. Thicker layers, e.g. >10 nm, >25 nm or even >100 nm such are effective. However, to minimize a contribution of the passivation layer to an overall weight of the electrode the thickness of metal- or metalloid-based passivation layers is preferably <200 nm, e.g. in a range of 5-10, 5-20 nm, 5-50 nm, 10-50 nm or 10-100 nm.

Inventors surprisingly found that the aim of providing an effective passivation layer 10 for shielding the carbon nanotubes from a direct contact with external materials while allowing electron transport to/from the structure of agglomerated carbon nanotubes can be equally attained by compositions generally considered as electrically insulating provided that such layers are functionally thin to allow electron tunneling across the coat while shielding the carbon-based protrusions below from a direct contact with external materials. Accordingly, in some embodiments the first composition 10c comprises or essentially consists of an electrically insulating composition, such as metal- and/or mixed metal oxides. For effective tunneling across the passivation layer, the surface of the carbon-based protrusions onto which the passivation layer 10 is applied should be in electrical contact with the substrate current collector 3. This is for instance the case for electrically conductive carbon-based protrusions such as carbon nanotubes, or polymer-based protrusions comprising a polymer material with a conductive filler.

Suitable materials that can be used in first composition 10c to form a tunnel junction include metal oxides, such as HfOx, ZrOx, LaOx, SiOx, AlOx, TiOx, mixed metal oxide compositions such as SrTiOx (STO) and BaSrTiOx (BST), as well as mixtures of metal oxides and/or mixed metal oxides. Particularly preferred materials include Silicon oxides, Aluminum oxides, Titanium oxides, and combinations thereof, conformal layers of which can be effectively provided by atomic layer deposition. The maximum thickness of a layer through which sufficient tunneling can occur depends on the material used, but is typically 5 nm or less. Therefore, a thickness of the insulator-based passivation layers is generally <5 nm, preferably 3 nm or less. A minimum thickness is generally >1 nm. Advantageously, conformal insulator based passivation layers 10 can be as thin as five monolayers. Advantageously metal-oxide based passivation layers were found particularly effective in shielding carbon nanotubes from electrode and electrolyte compositions, both under anodic and cathodic conditions.

In a preferred embodiment, in particular when the electrode 1 is for use as a part of or as an anode, the electrode 1 further comprises a seed layer 20 covering the scaffolding elements 4 for receiving an anode metal composition as shown in FIG. 1B. Advantageously the seed layer can be deposited directly onto the scaffolding element, i.e. without intermediate adhesion layer, minimizing an amount of dead material per unit volume. So as to further minimize a contribution to an overall weight of the electrode the seed layer 20 is preferably functionally thin, typically in a range of about 2 nm-about 100 or 200 nm, preferably 5-50 nm, where increasingly thick seed layers reduce a density of point defects at a cost of an increasing relative weight contribution. The seed layer 20 is generally formed of a composition 20c having a high affinity with one or more anode metal compositions selected from the alkali and alkaline-earth metals. As such the seed layer 20 can be understood to provide an effective wetting layer improving uniformity of anode metal layers deposited or plated thereon. Thereby mitigating or even essentially avoiding localized or uneven anode metal deposition, mitigating an occurrence of lithium dendrites and/or porous (mossy) anode metal layer growth, even upon prolonged battery cycling. As such provision of the seed layer 20 contributes to the aims of increasing battery safety (mitigate dendrite formation), improved cycling lifetime, and power density (mitigate porous/mossy anode metal formation). Suitable compositions include materials generally regarded as lithiophilic, sodiophilic, potassiophilic, etc). In some embodiments, the seed layer 20 comprises or essentially consists of a seed composition 20c alloying with the anode metal composition, e.g. having an affinity with the anode metal allowing formation of an admixture therewith having >10 wt % content of the seed element, e.g. >50%, or even 0-100 wt %. Particularly preferred seed compositions 20c include Zinc as well as Zinc oxides or Tin as well as Tin oxides, which are found to reduce to their corresponding metallic state, e.g. upon an initial contact with a more electropositive anode metal such as Li or Na or, preferably by a prior reduction step involving hydrogen. Both Zn and Sn and their oxides based seed layers can advantageously be provided as essentially closed conformal cover layers, e.g. by ALD. Of course, if the electrode is intended for use in or as an electrode at a cathode side of an energy storage application a seed layer for anode metal would not be required.

In a preferred embodiment, wherein the electrode is for use as or as part of an anode the electrode further comprises a layer of an anode composition, typically an anode metal composition, or cathode composition covering the plurality of scaffolding elements. With an anode composition the electrode is herein also referred to as a pre-filled anode or pre-filled 3D anode. With a cathode composition the electrode is herein also referred to as a pre-filled cathode or pre-filled 3D cathode.

FIGS. 1C through 1G illustrate features of the electrode as described herein for embodiments wherein the scaffold structure is embodied as comprising a carbon-based pillar 6p. The embodiment illustrated I FIG. 1C differs from embodiment described in relation to FIG. 1A primarily in that the pillar is formed of a polymer. Provided onto the carbon-based. e.g. polymer-based, pillar 6p is a passivation layer that covers the pillar from a base at the substrate 3, along its sidewalls, up to and including the tips of the polymer pillars. Polymer protrusions such as the polymer pillar structures can be provided by methods known in the field including, but not limited to, photolithographic patterning, (micro)imprinting), (screen)printing. In contrast to carbon nanotube based scaffolding elements polymer based scaffolding elements can have an aspect ratio (height/width) in a range that is smaller, e.g. preferably at least 1:1 to 10:10 or to 20:1.

The embodiment shown in FIG. 1D differs from embodiment described in relation to FIG. 1C primarily in that the pillars have tapered shape in a direction from a base 6b toward the tip 6t of the pillar. Tapering shaped protrusions are accessible using common method listed above, e.g. by using an appropriately shaped mold. The sidewalls can, but need not be, sloped in a continuous linear fashion as indicated.

In the embodiment shown in FIG. 1D the passivation layer further includes a portion 10p that connects between adjacent scaffolding elements 4. The portion 10p covers the substrate 3 surface between adjacent carbon-based, e.g. polymer-based, pillars 6p. To maintain high conductivity with the substrate 3, the interconnection section (portion 10p) is preferably metallic.

An optional intermediate layer (not shown) may be provided between scaffolding elements 4 and the substrate. Preferably the intermediate layer is made of a material that is chemically inert toward the substrate current collector. In this way, degradation of the substrate current collector by reaction with the scaffolding elements, for instance oxidation of the substrate current collector, can be mitigated or even avoided. Oxidation of the substrate current collector is unwanted, because it could negatively affect the structural integrity and/or electric conductivity of the current collector. Alternatively or additionally, adhesion of the scaffolding elements to the substrate current collector can be improved. In embodiments, the intermediate layer is only provided between scaffolding elements 4 and the substrate 3. In other embodiments, the intermediate layer may be also be provided on portions of the substrate between adjacent scaffolding elements 4, for instance on the entire substrate. In that case, it is preferred that the intermediate layer is made of an electronically conductive material that is compatible with additional layers that may be in (direct) contact with the intermediate layer, such as an alkali metal anode layer, and an electrolyte layer. Suitable materials for the intermediate layer include ceramic materials, such as metal oxides. In case the intermediate layer needs to be conductive, conductive oxides such as indium tin oxide are preferred.

In the embodiment shown in FIGS. 1E and 1F the passivation layer is a laminate. The laminate includes a metal base layer 10a and a cover layer 10b. The base layer 10a extends, but need not, between adjacent pillars. The cover layer 10b is comprised of a material having a lower electronic conductivity than the base layer, e.g. a semi-conductor. In contrast to the base layer the cover layer 10b does not extend between adjacent protrusions. Preferably, the cover layer 10b is restricted to the protrusion, e.g. as shown. In a preferred embodiment, e.g. as indicated in FIG. 1F the cover layer 10b has a thickness that increases from a minimum at or near a base 6b of the protrusion (e.g. pillar or wall) to a maximum at or near the top 6t of the protrusion.

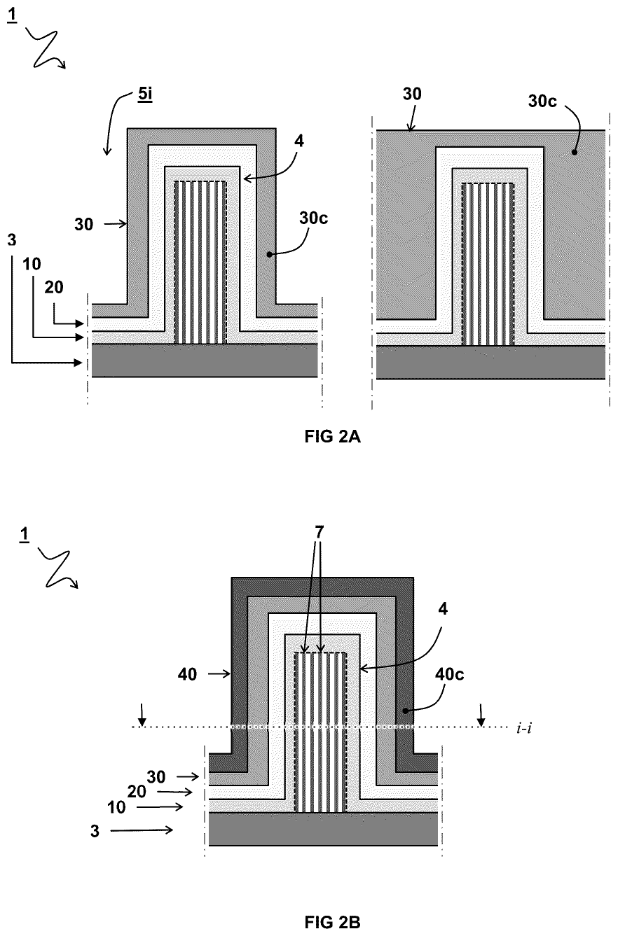

FIG. 2A depicts a partial cross-section side view of an embodiment of the electrode 1 including a layer of an anode metal 30. The anode metal layer comprises, or essentially consists of an anode metal composition 30c. As shown the layer is provided directly on top of the seed layer 20 and forms a homogenous cover layer over the scaffolding elements. The anode metal layer 30 also extends between adjacent scaffolding elements in a direction along adjacent scaffolding elements. By providing an anode metal composition 30c the electrode can be advantageously configured as a pre-filled anode for energy storage applications (e.g. batteries).

In some embodiments, e.g. as shown in FIG. 2A (left) the layer of anode metal composition 30c is configured so as to leave space at interspaces structures 5i between adjacent scaffolding elements for subsequent battery layers including one or more of electrolytes and/or anode materials, forming a 3D battery structure that can benefit from increased power density, relative to 2D layered battery structures, due to comparatively short ion diffusion distances as facilitated by depositing functional battery multilayers along the upstanding sidewalls of the scaffolding elements 4.

In some preferred embodiments, the anode metal essentially fills up the interspace structures between adjacent upstanding scaffolding elements, e.g. as shown in FIG. 2A (right) the scaffolding elements 4 are essentially embedded in the anode metal composition 30c. Embodiments, wherein the scaffolding elements 4 are essentially embedded in the anode metal composition 30c be understood to constitute a planar 2D anode having an internal 3D current collecting elements offering distributed current collection and improved field homogeneity, while benefiting from the passivation layer providing chemical and mechanical stability which can be used in battery storage applications. As compared to 3D layered battery structures battery structures including a planar 2D anode can advantageously offer comparatively capacity per unit volume.

Obviously the anode metal composition can be provided directly onto the carbon-based protrusion 6, i.e. without passivation layer 10. However, such configuration would not benefit from the advantages, including improved structural and electrochemical stability, as provided by the passivation layer as disclosed herein.

Suitable anode materials include compositions comprising metal elements selected from the alkali and/or earth alkaline groups. Preferably, one or more of lithium, sodium, potassium and magnesium, of which lithium is particularly preferable for energy storage applications benefitting from a maximized oxidation potential offered by Li. In some embodiments, the anode metal composition is an alloy including one or more elements selected from the alkali and/or earth alkaline groups alloyed with one or more transition metal elements or metalloid elements such as zinc. Alloying reduces an overall reactivity of the composition towards oxidation, in particular oxidation during electrode/battery manufacturing or assembly due to contact with ambient, at a cost of a theoretical penalty in attainable overall energy density and/or oxidation potential. Inventors found that losses due to alloying an alkali or alkaline earth-based anode metal composition with a comparatively less reactive (less electronegative metal composition, e.g. Li—Zn (90/10 w/w) of Li—Zn (80/20) can outweigh performance losses due to oxidation of an anode metal composition that essentially consists of an alkali or alkaline earth-based anode metal composition, in particular losses imparted during manufacturing under conventional typical dry-room manufacturing conditions (atmosphere with O2, N2, and CO2, but essentially without water vapor). Accordingly, in a preferred embodiment, the anode metal composition comprises an alloy between one or more metals selected from the alkali or alkaline earth-based anode metal composition preferably lithium, and between 5 and 30 weight percent of a composition alloying therewith, said composition comprising or essentially consisting elements selected from groups 12-14, preferably, one or more of Zn, Sn, In, Al and Si, more preferably including at least Zn.

It will be understood that anode metal layer can be suitably provided, e.g. as conformal cover layer or essentially filling up the interspace structures, by known deposition methods including, by not limited by, dry vapor deposition methods such as PVD and ALD, melt deposition, and wet deposition processes such as electroplating.

Alternatively an electrode can be manufactured without an anode metal layer. Such electrode can be used at an anode-side of an energy storage application (e.g. a Li-metal battery) whereby the anode metal is provided by an in-situ plating procedure (conditioning step) whereby anode metal is plated onto the scaffold by reducing metal ions from an electrolyte composition. Compared to pre-filled embodiments electrodes without anode metal layers can advantageously benefit from comparatively increased shelf life.

Yet further alternatively the anode or cathode composition can be provided as particulates, e.g. by depositing as slurry with a volatile carrier. Accordingly, in some embodiments the electrode comprises particles of an anode material, said particles at least partially filling up interspace structures between upstanding scaffolding elements. Accordingly, in some embodiments the electrode comprises particles of a cathode material, said particles at least partially filling up interspace structures between upstanding scaffolding elements. It will be understood that, for embodiments comprising a cover with particles of an anode material the scaffolding elements can advantageously further include one or more of the functional conformal layers as described herein, such as the seed layer to improve anode metal (e.g. lithium) plating homogeneity (e.g. during a battery charging routine), and/or an electrically insulating cap 50 to reduce an electric field near tips of the scaffold structures.

To improve electrical and/or ionic contact to/from anode material, respectively cathode material, in particular for electrodes comprising particulates of an anode material (respectively a cathode material) the electrode is preferably further provided with a corresponding catholyte or anolyte composition. The catholyte/anolyte can advantageously bridge an ion/electron condition pathway between electrode and an overlying separator structure and/or solid or semi-solid electrolyte. For electrodes comprising a particulate anode/cathode material composition the anolyte/catholyte can advantageously fill remaining interstice volumes between particles further improving electron/ion conduction between adjacent particles.

In some preferred embodiments, if the electrode comprises a layer of an anode metal composition, the electrode can advantageously further comprise an anode passivation layer.

FIG. 2B depicts a partial cross-section side view of the embodiment of the electrode 1 shown in FIG. 2A (left) further comprising an anode passivation layer 40. The anode passivation layer 40 is comprised of, or essentially consists of, a passivation composition 40c. The anode passivation layer 40 forms a conformal cover layer that shields the underlying anode metal composition 30c from a direct contact with ambient. Obviously the anode passivation layer 40 can be provided with similar benefit for embodiments wherein the scaffolding elements 4 are essentially embedded in anode metal composition 30c (e.g. as shown in FIG. 2A, right).

To protect the underlaying anode while minimizing its electrochemical activity the passivation layer is formed of a composition comprising, or essentially consisting of, an anode metal- or at least anode metal ion-conductive or miscible composition having comparatively reduced reactivity towards one or more of O2, N2, CO2, and H2O, preferably all. An anode-metal-conductive or anode-metal-ion conductive or miscible composition can be understood as a composition having a non-zero, typically at least 5%, preferably more e.g. >10% or >25%, solubility by weight for alkali and/or alkaline earth metal based anode metal compositions as comprised in the anode layer and/or the corresponding ions. Suitable compositions include compositions comprising, or essentially consisting of, elements selected from groups 12-14, preferably one or more of Zn, Sn, In, Al and Si, which are all found to alloy with desirable anode metal compositions such as Li, Na, Li/Na while each having a comparatively reduced reactivity to at least one of O₂, N₂, CO₂, and H₂O. The metal or metalloid can be suitably deposited using known processes, for instance by PVD. Most preferably the passivation composition includes at least Zn or Tin which were found to be particularly effective in shielding underlying anode metals, e.g. Li, from degradation by O₂, N₂, H₂O and CO₂, while being suited for layer deposition by dry depositions techniques including PVD and ALD. The passivation layer is preferably suitably thin so as to mitigate reaction of the underlying anode metal composition with constituents from ambient. Preferably, the layer has a thickness of at least 5 nm. To mitigate point defect density the layer can be thicker, e.g. ≥10 nm. To minimize an overall weight contribution of the anode passivation layer the thickness is preferably about 250 nm, e.g. 5-200 nm, 10-100 nm, or 20-50 nm. In some embodiments, the passivation layer is essentially comprised of a layer of one or more of Sn, Zn, or Al, having a thickness in a range of 5-250 nm. Inventors found that each of Sn, Zn, or Al provide adequate solubility of anode metals such as lithium and sodium while mitigating their oxidation during electrode manufacturing and/or battery assembly under dry room conditions while having negligible effect on power density.

It will be appreciated that, in view of the mutual solubility of the compositions making up the anode metal layer 30 and the anode passivation layer 40, it may be difficult to discern a clear transition/boundary between the anode passivation layer and the anode metal layer, in particular with increasing battery cycling routines (charging/discharging routines).

Alternatively, or in addition, the anode passivation layer may comprise stable solid electrolyte interphase (SEI) composition. SEI compositions are known in the field and can be formed due to irreversible reactions between constituents of an anode metal and corresponding electrolyte composition. In the present disclosure it is particularly envisioned to provide a stable SEI coating by reaction with a dedicated electrolyte composition using a dedicated wet-electrochemical deposition process. Engineering Reports 2021; 3:e12339 by Gu et al, which is hereby incorporated by reference in its entirety, discusses a number of reports on formation of stable SEI layers (section 3.3) and lithium-alloys (section 3.1) which are herewith also incorporated by reference.

Note that embodiments described in relation to FIGS. 2A and 2B are not to be construed as being limited to carbon nanotube 7 based pillars but that the description also applied to other carbon-based protrusion, especially polymer based protrusion such as pillars and wall structures as described in relation to FIGS. 1C-1G and 7B.

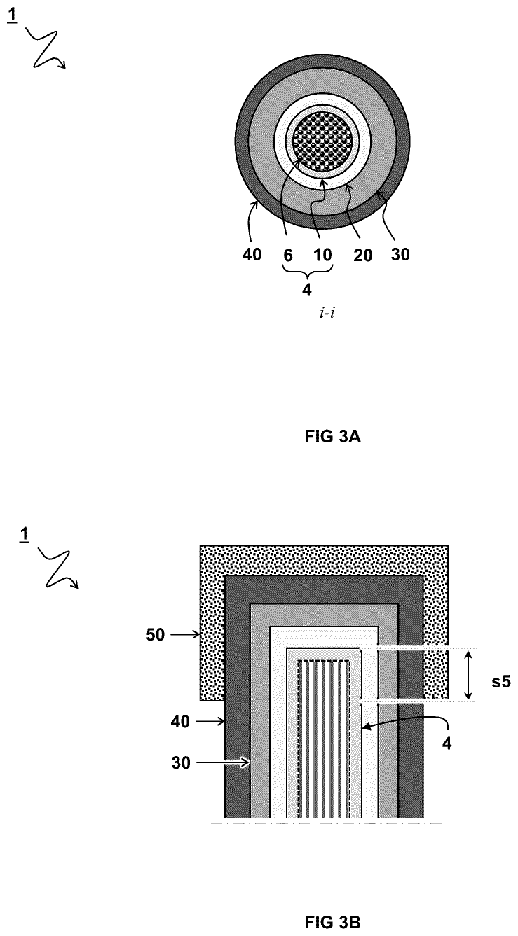

FIG. 3A provides a depicts a cross section top-view of an electrode as shown in FIG. 2B shown a scaffolding element 4 comprising a stack of conformal cover layers including a seed layer 20, an anode metal layer 30, and an anode passivation layer 40. In this particular embodiment the carbon-based protrusion 6, illustrated as a structure of agglomerated carbon nanotubes is shaped as an isolated pillar with a circular cross-section. While isolated structures in general, and isolated pillars in particular, can be preferred for offering a maximal surface to volume ratio, it will be appreciated that the disclosure is not to be interpreted as being limited to such structures. Inventors explicitly also envision differently shaped isolated structures, e.g. having a square or different polygonal cross-section, but also structures, e.g. walls, having an elongated cross-sectional dimension in a direction along the electrically conductive substrate current collector, or even interconnected structures such as interconnected wall-sections, such as hexagonally interconnected wall sections as shown in FIG. 7B. Interconnected structures may offer a particular benefit of comparatively improved mechanical stability, e.g. resistance to bending and/or delamination over structures with isolated protrusions. Wall structures, in particular wall sections of interconnected structures may further be provided with one or more channels that at least partially interrupt the wall section. Such channels improve access to the space between adjacent wall sections for subsequent layers, e.g. an electrolyte layer, that may be applied to the electrode when manufacturing a battery.

To mitigate cracking or structural damage, especially for agglomerated carbon nanotube structures or thin polymer based structures, a lateral dimension of an isolated or interconnected structure preferably does not exceed 10 mm. typically <1 mm. By limiting a lateral dimension of the interconnected structures one allows bending of the underlaying substrate, and indeed of the electrode as a whole, without losing essential functionality.

In a preferred embodiment, the carbon-based protrusions 6 such as the structure of agglomerated carbon nanotubes or the polymer-based protrusions (e.g. pillars/wall structures having an elongate dimension in a lateral direction along the substrate) are segmented in sectors, each sector separated by an adjacent one across a gap. Accordingly, in a preferred embodiment, the carbon-based protrusions 6 are segmented in sectors having a lateral separation in accordance with a substrate bending axis. The gap typically has a dimension in a range with a lower limit of about the 5 μm. Preferably, the gap is at last equal to the height of the protrusion, e.g. the height of the polymer-based pillar or carbon nanotubes, e.g. 5-100 μm. Further separations can enable a smaller bending radii. An upper limit can be as larger as several millimeters or more. Typically separations are in a range of 5-2000 μm, Preferably, 50-1000 μm, more preferably, 100-500 μm.

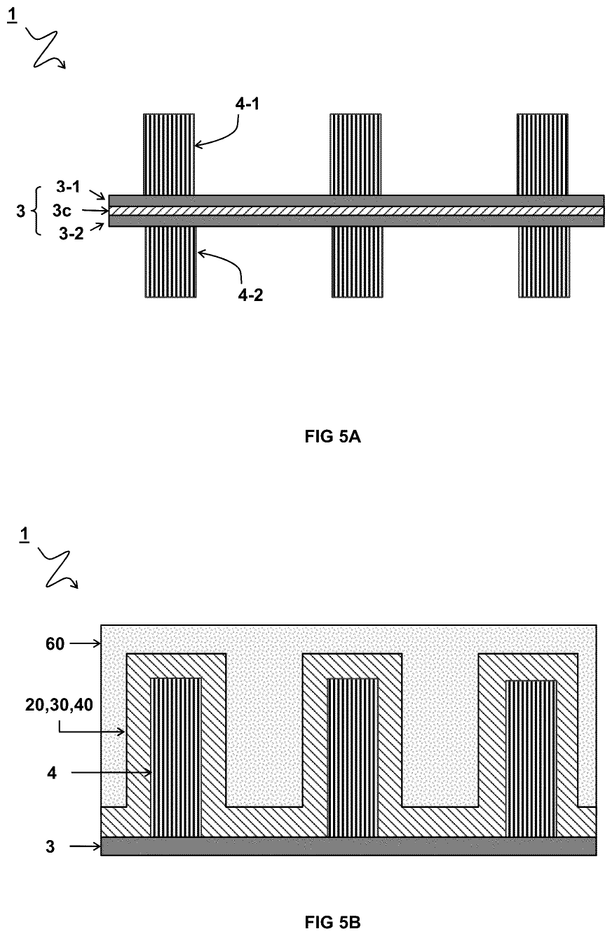

Alternatively, or in addition, e.g. as shown in FIG. 5A, the upstanding scaffolding elements 4 can be provided on opposing surfaces of an electrically conductive substrate current collector. FIG. 5A illustrates an embodiment comprising an electrically conductive substrate current collector 3 comprising a flexible polymer carrier film 3c that has been coated on opposing faces with a copper film 3-1,3-2. Both faces of the electrically conductive substrate current collector 3 have been provided with respective ones 4-1,4-2 of the upstanding scaffolding elements 4 as disclosed herein.

The scaffolding elements on the opposite sides of the substrate can be covered with the same electrode material (e.g. identical or similar anode or cathode compositions on both sides). Alternatively the scaffolding elements can be provided on one side with the anode material and on the other side with the cathode material (e.g. in the case of bipolar stacking). In case of bi-polar stacking, the layers 3-1 and 3-2 typically do not comprise the same metal (Cu). Instead it can be preferred that one side is coated with Cu and the other side is coated with another metal, preferably Al. It well be understood that the selection can depend on the voltage of the electrode materials.

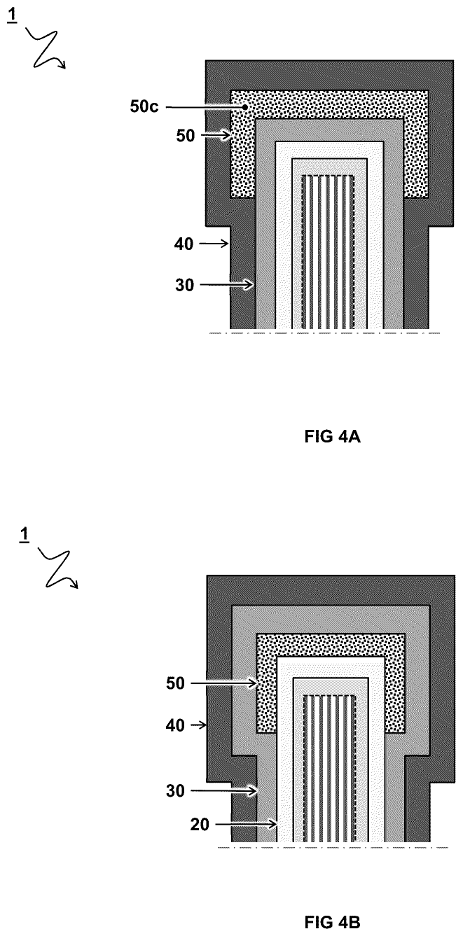

In some preferred embodiments, electrode further comprises an electrically insulating cap. FIGS. 3B, 4A, and 4B depict various embodiments of a 3D anode including an electrically insulating cap. The cap 50 covers the top section s5 of the scaffolding elements. Cap 50 may for instance be provided between seed layer 20 and anode metal layer 30, between anode metal layer 30 and anode passivation layer 40, and/or covering anode passivation layer 40. By covering the top sections of the conducive scaffolding elements an electric field can be effectively reduced at positions near the top sections of the upstanding scaffolding elements. Reducing an electric field near top sections of the scaffolding elements 4 can advantageously mitigate uneven anode metal, e.g. lithium, deposition during a battery cycling. Mitigating uneven anode metal deposition near tops of the scaffolding structure can reduce or eliminate dendrite formation which can cause short circuit situations. Mitigating uneven anode metal deposition near tops of the scaffolding structure was further found to improve homogeneity of anode metal deposition along uncoated sidewall sections of the structures and this improves cycling lifetime and/or power density during battery operation.

The cap is preferably formed of metal- or mixed-metal oxides or other dielectric inorganic compositions 50c. The higher the dielectric constant the thinner the capping layer can be for a given insulating effect Preferably, the insulating composition 50c has a dielectric constant that is at least about 1, more preferably a k>10 or even a k>100. Suitable compositions include SiOx, AlOx, TiOx, HfOx, ZrOx, LaOx, and mixed metal oxide compositions, such as STO (SrTiOx), BST (BaSrTiOx), as well as mixtures thereof. A non-limiting description of exemplary dielectric compositions may be found in Jain et al., IEEE Trans. Advanced Packaging 25 (3) 454 (2002), which is hereby incorporated by reference. It will be understood that the insulating caps are deposited, e.g. by dry vapor deposition methods, such that a bottom portion of the scaffold remains essentially uncovered by the cap. Generally the cap is confined to tops of the scaffolding element. Typically the cap extends over a length of the sidewalls of the scaffolding element over a distance which is <25% of the length of the carbon nanotubes.

In one embodiment, the cap is provided directly onto the passivation layer. Alternatively, or in addition, the cap can be provided directly over the seed layer (FIG. 4B), the anode metal layer (FIG. 4A), or the anode passivation layer (FIG. 3B). Preferably, the cap covers the anode metal, as shown in FIGS. 4A and 3B. When the cap is provided over the anode metal layer or the anode passivation layer the anode metal 30 below the cap 50 can act as a buffer replenishing potential anode metal losses incurred during battery operation.

As for the passivation layer 10 and the anode passivation layer 40 the cap 50 is preferably functionally thin to minimize an overall contribution of insulation material per unit volume while significantly reducing electron conduction to tops of scaffolding elements. Typically the capping layer 50 has a thickness in a range of 5-200 nm, e.g. 10-100 nm or 10-50 nm, whereby the thickness for high-k dielectric compositions (e.g. k>10) can advantageously be at a lower end of said ranges, e.g. 5-20 or 5-10 nm.

In yet further embodiments, the electrode 1 further comprises an electrolyte. FIG. 5B illustrious an embodiment comprising an electrolyte 60 covering the scaffolding elements 4. The embodiment shown also includes a conformal stack of functional layers including a seed layer 20, an anode metal layer 30, and anode passivation layer 40 (represented by a single layer for clarity).

The electrolyte 60 is typically applied to electrodes comprising a pre-filled amount of anode metal composition, i.e. covering anode metal layer. Preferably, to protect the anode composition from reaction with ambient the anode layer is protected by an anode passivation layer. Alternatively the electrolyte 60 can be applied to electrodes without pre-filled amount of anode metal 30 and anode passivation layer 40. In such cases the anode composition can be plated from the electrolyte onto the scaffolding elements by an in-situ plating process. The electrolyte 60 can be a solid state electrolyte layer, a liquid electrolyte, or a so-called semi-solid electrolyte comprising mobile ions, e.g. an ionic liquid and/or ions dissolved in an appropriate solvent, dispersed in a solid matrix, e.g. a polymer network (e.g. a gel) or porous ceramic network. Solid or semi-solid electrolytes can be particularly preferred for embodiments wherein one or more subsequent layers are to be deposited onto the electrolyte. The presently disclosed electrode configuration, comprising an essentially closed passivation layer advantageously allows or enables application of semi-solid electrolytes or even liquid electrolytes having comparatively high ion mobility than their solid counterparts.

In some embodiments, e.g. as shown, the electrolyte fills remaining elongate interspace regions between the scaffold. Alternatively, solid or semi-solid electrolytes can be provided as a conformal cover layer covering the scaffolds whereby subsequent battery layers can be provided in remaining interspace regions. In a preferred embodiment subsequent battery layers include an electrolyte having a comparative higher ion conductance, such as a liquid electrolyte, to improve ion diffusivity within the structure.

It will be understood that the electrolyte 60 can also be provided as a planar layer, optionally in conjunction with an analyte composition, e.g. from embodiment wherein the electrode is configured as a planar 2D anode with integrated 3D current collector, e.g. as in FIG. 2A (right).

Further aspects relate to an energy storage device, e.g. a lithium metal battery, comprising the electrode 1 as disclosed herein. Advantageously the electrode can be used at one or more of a cathode and anode side of the energy storage device.

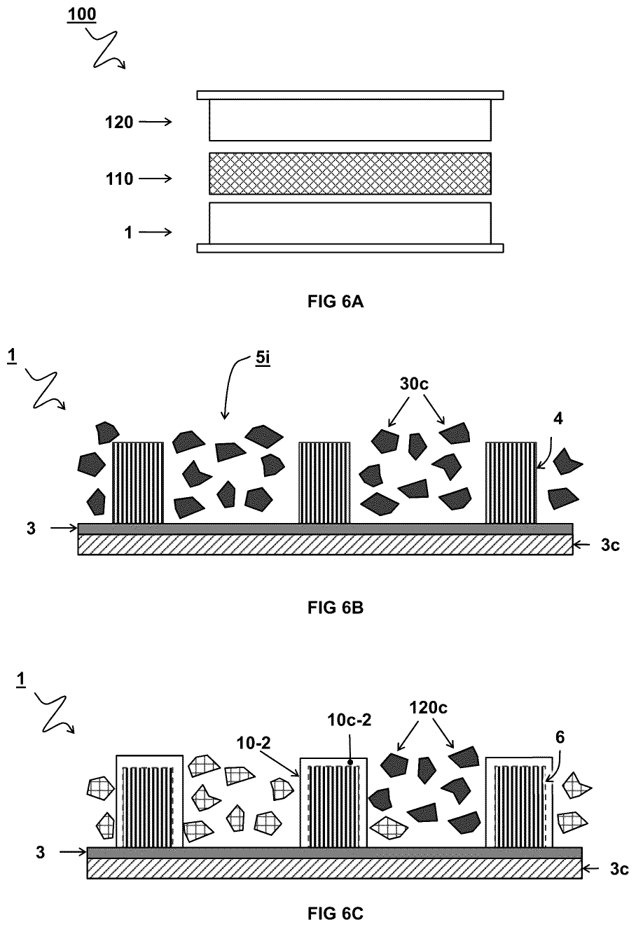

FIG. 6A schematically illustrates an exploded side view of a battery 100 comprising an electrode 1 as disclosed herein. In one embodiment, e.g. as shown, the electrode is comprised at an anode side of the battery. The cathode side can be a conventional cathode 120 including a current collector and cathode composition. Alternatively, or in addition, the electrode 1 can also be used at a cathode side of the battery, e.g. by providing a cathode composition over and/or between the upstanding scaffolding elements 4. For embodiments wherein the electrode 1 is used as current collector at an anode side of an energy storage application the passivation layer 10 equally protects the underlying carbon nanotubes. Obviously a seed layer and anode passivation layer are dispensed with.

A separator 110, provided between the anode and cathode physically separates the cathode from the anode, preventing a short circuit, while enabling ion transport. The separator 110 can be comprised of, or essentially consists of, an electrolyte layer, e.g. a solid or semi-solid electrolyte layer as described in relation to FIG. 5B. Alternatively, or in addition, the separator can be provided as a porous carrier structure comprising a liquid electrolyte composition. To improve wetting and ion transport a catholyte composition can respectively be provided at an interface between the cathode and a cathode side of the separator 110. Alternatively, or in addition, an anolyte composition can be provided at an opposing interface between the anode and an anode-side of the separator. In a preferred embodiment, the energy storage device comprises a composite solid electrolyte membrane separating the anode and cathode. As explained the anode and/or cathode may be provided as planar 2D electrodes with an integrated current collector. Alternatively on or more of the anode and cathode, optionally both, can be configured as 3D electrodes comprising a conformal stack of a battery multilayer.

FIGS. 6B and 6C illustrate further aspects of an electrode as disclosed herein, comprising a particulate anode/cathode composition comprising a plurality of discrete particles of anode/cathode composition. The particulate anode/cathode composition fills the interspace structures between adjacent upstanding scaffolding elements 4. To electrically contact the particulate anode/cathode composition may comprise an electrically and/or ion conductive matrix. Advantageously, the particulate anode/cathode composition can be deposited, e.g. following passivation layer 10 deposition from a slurry comprising a volatile carrier liquid. FIG. 6B illustrates an embodiment wherein the electrode 1 is configured as an anode, whereby interspace structures 5i between adjacent scaffolding elements as filled with particles comprising or essentially consisting of the anode metal composition 30c, e.g. Li. The scaffolding elements 4 can advantageously include a seed layer 20 (not shown) to improve homogeneity of anode metal plating during battery cycling. FIG. 6C illustrates an embodiment wherein the electrode 1 is configured as a cathode, whereby interspace structures 5i between adjacent scaffolding elements as filled with particles comprising or essentially consisting of a cathode composition 120c. As for the anode the carbon-based protrusions 6 are protected from direct contact with cathode material and/or electrolyte by a passivation layer 10-2. In contrast to anode side-applications the passivation 10-2 layer is preferably comprised of, or essentially consists of, aluminum 10-2c.

Further aspects relate to a method of manufacturing an electrode as disclosed herein. As schematically represented in FIG. 7A, the method 200 comprises at least the steps of: providing 205 a 3D composite substrate current collector having an electrically conductive substrate current collector comprising a plurality of laterally distributed structures of agglomerated carbon nanotubes oriented largely parallel in a direction away from the substrate; and forming a plurality of laterally distributed electrically conductive scaffolding elements having upstanding sidewalls by 210 covering the structures of agglomerated carbon nanotubes with a passivation layer of a first composition for shielding the carbon nanotubes from a direct contact with an electro-active material (e.g. anode metal) while allowing electron transport to/from structure of agglomerated carbon nanotubes. The agglomerated tube structures can be suitably covered by the first composition using known dry deposition methods including but not limited to atomic layer deposition (ALD), spatial atomic layer deposition (sALD), and physical vapor deposition methods (PVD) such as such ionized physical vapor deposition (iPVD). ALD-based method can advantageously form conformal cover layers encapsulating the underlying carbon nanotubes already after only a couple of deposition cycles, e.g. >5 deposition cycles, yielding a thin passivation layers (<5 nm) having suitable electrical conductivity even for materials which are conventionally considered to be electrical insulators (e.g. SiOx and AlOx). Optionally deposition of the first composition may be followed by a reduction step, e.g. under hydrogen atmosphere, to at least partly convert (reduction) compositions, e.g. ZnO, to a comparatively more conductive metallic form. Alternatively, or in addition a passivation layer, in particular a SEI-based first composition can be provided by wet-depositions method including but not limited to electroplating.

In case an optional intermediate layer is provided between scaffolding elements 4 and the substrate 3, such a layer can be applied to the substrate before using the same techniques that can be used for covering the scaffolding elements with the passivation layer, i.e., using known dry deposition methods including but not limited to atomic layer deposition (ALD), spatial atomic layer deposition (sALD), and physical vapor deposition methods (PVD) such as such ionized physical vapor deposition (iPVD).

Following deposition 210 of the passivation layer, the process can subsequently include a step of depositing 220 a seed layer onto the formed upstanding scaffolding elements. The seed layer can be conveniently deposited directly onto the passivation layer by dry deposition methods as mentioned above.

In some embodiments, the method includes a step of depositing 230 an anode metal layer, preferably directly onto the formed seed layer. Anode metal layers can be deposited by known methods including by not limited to dry deposition method such as ALD and PVD, and wet-deposition methods such as electroplating. Alternatively, an anode or cathode composition can be deposited as particles, as shown in FIG. 6B, from a slurry comprising a suitably volatile carrier solvent.

In some preferred embodiments, the method further comprises covering 240 the anode metal layer or particles with an anode passivation layer. The anode passivation layer can be provided by dry deposition methods, optionally followed or in conjunction with a reduction procedure (e.g. with hydrogen) to reduce formed oxides to metallic compositions.

In other or further preferred embodiments, the method includes a step of covering 250 top portions of the upstanding scaffolding elements by an electrically insulating cap. The cap can be suitably provided by dry deposition methods, e.g. physical vapor deposition under a shallow angle to mitigate insulator deposition along bases of the structures, or by ALD, whereby the device is controlled so as to limit deposition to the tops of the scaffolding elements, e.g. by under-exposing (e.g. temporal and/or concentration) the structures for complete conformal coverage of the scaffolding elements. In some embodiments, e.g. as shown in FIGS. 7A and 3B, the cap by be provided after providing the anode passivation layer. Alternatively, or in addition, a cap can be provided between steps 230 and 240 (e.g. as shown in FIG. 4A), between steps 220 and 230 (e.g. as shown in FIG. 4B), or between steps 210 and 220, i.e. directly onto the formed upstanding scaffolding elements.

The substrate current collector having an electrically conductive substrate current collector comprising a plurality of laterally distributed structures of agglomerated carbon nanotubes oriented largely parallel in a direction away from the substrate can be formed by methods known in the field, including micropatterning of dense carbon nanotube structures. In a preferred embodiment, forming the plurality of laterally distributed structures of agglomerated carbon nanotubes oriented largely parallel in a direction away from the substrate includes a step of growing 202 carbon nanotubes from buffer layer provided along a face of an electrically conductive substrate current collector, the buffer comprising an oxide layer and distributed catalyst or seed particles for growing carbon nanotubes. After growing the carbon nanotubes an agglomerated structure of carbon nanotubes can formed by agglomerating 203 the formed forests of individual carbon nanotubes to condensed agglomerated structures, e.g. by known methods including thermal and capillary agglomeration, e.g. by exposing to a volatile solvent followed by evaporating the solvent.

A degree of agglomeration (DOA) can be characterized as a percentage of void fraction between adjacent carbon nanotubes within the structure relative to an initial void fraction (i.e. prior to densification). Herein a DOA=0% corresponds to a non-agglomerated condition (as-grown VACNT) having 100% void-fraction. Accordingly, in a preferred embodiment, the DOA is at least 5%, preferably >20%, most preferably larger, e.g. >40% or even in excess of 60%. The smaller the remaining void fraction within an agglomerated structure the larger its structural integrity and larger the volume fraction of active materials within the device can be.

To control the dimensioning and spacing of the carbon nanotube structures the method can include patterning 201 the buffer layer, e.g. by micropatterning methods such as mask lithography.

Specifically in case the protrusions are polymer protrusions the manufacturing can comprise corresponding polymer processing methods as known in the field. Suitable method including subtractive and/or additive method including but not limited to photolithographic patterning, (micro)imprinting, (screen)printing. In one embodiment, providing the polymer protrusions can include the steps of: coating the substrate with a one or more suitable precursor e.g. a cross-linkable polymer layer; followed by mechanically structuring the coating, e.g. by applying an appropriately structures mold or stamp, curing the structured coating, e.g. by thermal of photocuring, and removing the mold or stamp, leaving behind a 3D structured coating on the substrate. Optionally, the method can comprise removal of a residual layer at the bottom of the structure (between the protrusions), e.g. by wet or dry etching.

FIG. 7B (left) schematically illustrates a partial top view of an electrically conductive substrate current collector 3 including a patterned buffer layer 7B with individual vertically oriented carbon nanotubes 7 grown therefrom prior to agglomeration. FIG. 7B (right) illustrates the same area after capillary agglomeration. As shown, the carbon nanotubes have agglomerated in a hexagonal arrangement of wall segments having comparatively high density of carbon nanotubes per unit area (significant reduction of interstice volume between adjacent carbon nanotubes). Of course, agglomeration methods can be used to manufacture a broad range of structures, other than the embodiment depicted.

For the purpose of clarity and a concise description, features are described herein as part of the same or separate embodiments, however, it will be appreciated that the scope of the invention may include embodiments having combinations of all or some of the features described.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. An electrode (1), comprising
a 3D composite current collector (2), comprising an electrically conductive substrate current collector (3) with a plurality of laterally distributed electrically conductive upstanding scaffolding elements (4),
wherein the scaffolding element (4) comprises:
a polymer-based protrusion (6) extending in a direction away from a base at the substrate; and
a passivation layer (10) covering upstanding sidewalls inclusive a tip of said polymer-based protrusion to shield the polymer-based protrusion from a direct contact with an electrode material and/or an electrolyte material, whereby said passivation layer (10) is comprised of a first composition (10c) allowing electron transport to the substrate and resistive to transport of alkali metal and alkali metal-ions across the passivation layer.

2. The electrode according to claim 1, wherein the polymer-based protrusion is tapered towards the tip.

3. The electrode according to any of the preceding claims wherein the passivation layer (10) includes a metal layer, which metal layer optionally includes a portion extending along a face of the substrate thereby interconnecting adjacent ones of the electrically conductive upstanding scaffolding elements.

4. The electrode according to any of the preceding claims, wherein passivation layer (10) includes a layer of a semi-conducting ceramic.

5. The electrode according to any of the preceding claims wherein the passivation layer (10) is a is laminate, said laminate including: the metal layer according to claim 3 and that includes the portion extending along a face of the substrate interconnecting adjacent ones of the electrically conductive upstanding scaffolding element; and a layer of the semi-conducting ceramic according to claim 4 provided onto the metal layer, whereby the semi-conducting material has a lower electrical conductivity than the metal layer, and whereby the layer of the semi-conducting ceramic does not interconnect adjacent ones of the electrically conductive upstanding scaffolding elements.

6. The electrode according to any of the claims 4-5, wherein a thickness of the layer of the semi-conducting ceramic along the upstanding sidewall increases in direction towards the tip.

7. The electrode according to any of the preceding claims, further comprising a sublayer extending between the protrusion and the passivation layer (10), said sublayer consisting of an electric insulator and not interconnecting adjacent ones of the electrically conductive upstanding scaffolding element.

8. The electrode according to any of the preceding claims, wherein the first composition (10c) comprises a metal or metal alloy, selected from: Cu, Ni, Al, Ti and alloys thereof.

9. The electrode according to any of the preceding claims, wherein the first composition (10c) comprises an electrical insulator having a thickness and resistivity configured to form a tunnel junction.

10. The electrode according to any of the preceding claims, further comprising an intermediate layer between the scaffolding elements (4) and the substrate current collector (3), wherein said intermediate layer is chemically inert toward the substrate current collector (3).

11. The electrode according to any of the preceding claims, wherein the electrode (1) further comprises a seed layer (20) that at least partially covers an outer face of the scaffolding elements (4) for receiving an anode metal composition (30c), wherein the seed layer (20) comprises a composition (20c) selected for alloying with alkali anode metal.

12. The electrode according to any of the preceding claims, further comprising an alkali metal anode layer (30) covering the plurality of scaffolding elements (4).

13. The electrode according to claim 12, further comprising an anode passivation layer (40) covering the alkali metal anode layer (30),

[symbol]

14. The electrode according to claim 13, wherein the anode passivation layer (40) comprises a metal or metalloid composition (40c) alloying with the alkali metal.

15. The electrode according to any of the preceding claims, further comprising an electrically insulating cap (50) covering the tops (s4) of the scaffolding elements (4).

16. The electrode according to claim 15, wherein the electrically insulating cap (50) is provided: onto the anode passivation layer (40), between the anode metal layer (30) and the anode passivation layer (40), or onto the seed layer (20).

17. The electrode according to any of the preceding claims, further comprising an electrolyte (60) covering the scaffolding elements (4).

18. The electrode according to any of the preceding claims, further, comprising particles of an anode or cathode material (30c,120c).

19. The electrode according to any of the preceding claims, wherein the scaffolding element has an aspect ratio as defined by a height of divided by its width in a range of 1:1 to 20:1.

20. The electrode (1) according to any of the preceding claims, wherein the electrically conductive substrate (3) is provided as flexible metal foil or as a metal coated flexible carrier.

21. The electrode (1) according to any of the preceding claims, wherein the laterally distributed electrically conductive upstanding scaffolding elements are segmented in sectors having a lateral separation aligned in accordance with a substrate bending axis.

22. The electrode (1) according to any of the preceding claims, comprising respective ones of the scaffolding elements (4-1, 4-2) on opposing sides of the electrically conductive substrate (3).

23. An energy storage device (100) comprising the electrode (1), according to any of the preceding claims.

24. The energy storage device according to claim 23, wherein the storage device comprises a composite solid electrolyte membrane separating opposing anode and cathode sides of the storage device.

25. A method of manufacturing the electrode according to any of claims 1-22, comprising
providing a 3D composite substrate current collector (2), having an electrically conductive substrate current collector (3) comprising a plurality of laterally distributed polymer-based protrusions extending in a direction away from a base at the substrate, and
covering upstanding sidewalls inclusive a tip of said polymer-based protrusions with a passivation layer (10) comprised of a first composition (10c) allowing electron transport to the substrate and resistive to transport of alkali metal and alkali metal-ions across the passivation layer.
